(19) United States
(12) Patent Application Publication
(10) Pub. No.: US 2016/0335245 A1
(43) Pub. Date: Nov. 17, 2016

(54) Systems and Methods of Enhanced Check in Technical Documents

(71) Applicant: COX COMMUNICATIONS, INC., Atlanta, GA (US)

(72) Inventors: Robert Clark Whitten, Kennesaw, GA (US); John Gordon Hood, Duluth, GA (US); Ronald William Noseworthy, Auburn, GA (US)

(73) Assignee: COX COMMUNICATIONS, INC., Atlanta, GA (US)

(21) Appl. No.: 14/713,622

(22) Filed: May 15, 2015

(51) Int. Cl. G06F 17/27

(52) U.S. Cl. CPC G06F 17/2705; G06F 17/273; G06F 17/274

(57) ABSTRACT

Systems and methods are disclosed for providing an improved spell check including identifying one or more excluded document sections and performing the document check function on the document except for the one or more excluded document sections. The excluded document sections may be delineated in a number of ways.

### TECHNICAL FIELD

The present disclosure is generally related to file processors and, more particularly, is related to an enhanced check for technical documentation.

### BACKGROUND

Use of currently available spell checking functions on certain types of documents will often result in errors with many words marked as incorrectly spelled. Technical documents, for example, often include newly created terms/words that are not part of a conventional dictionary. One drawback to this is that the user is left to constantly respond to misspelled word dialogs with options such as “ignore,” “add to dictionary,” and “change word” when running a spell check.

While some programs allow the user to add a custom dictionary such as those containing medical or legal terms, this does not resolve the issue when new technical terms are created/introduced for the first time. There are heretofore unaddressed needs with previous solutions.

### SUMMARY

Example embodiments of the present disclosure provide systems for providing document check function improvements. Briefly described, in architecture, one example embodiment of the system, among others, can be implemented as follows: a processor comprising a computer-readable medium with a set of instructions operable to parse a document from a specified position, identify a designated document section by locating a first designator within the document where the first designator indicates the beginning of a portion of the document to be bypassed by the document check function and locating a second designator within the document where the second designator indicates the end of the portion of the document to be bypassed by the document check function, and perform the document check function on the document except for the designated document section.

Embodiments of the present disclosure can also be viewed as providing systems for providing document check function improvements. Briefly described, in architecture, one example embodiment of the system, among others, can be implemented as follows: a processor comprising a computer-readable medium with a set of instructions operable to identify one or more excluded document sections in the document, and perform the document check function on the document except for the one or more excluded document sections.

According to still yet another embodiment of the present disclosure, example embodiments of the present disclosure provide document check function improvements that can be implemented as follows: a processor comprising a computer-readable medium with a set of instructions operable to identify one or more excluded document sections by locating an open designator within the document where the open designator indicates the beginning of a portion of the document to be bypassed by the document check function and locating a close designator within the document where the close designator corresponds to the open designator and indicates the end of the portion of the document to be bypassed by the document check function, and perform the document check function on the document except for the one or more excluded document sections.

### BRIEF DESCRIPTION OF THE DRAWINGS

FIG. 1 schematically illustrates a document excerpt in accordance with an example embodiment of the disclosure.

FIG. 2 schematically illustrates a document excerpt in accordance with an alternate example embodiment of the disclosure.

FIG. 3 schematically illustrates a document excerpt in accordance with an alternate example embodiment of the disclosure.

FIG. 4 is a block diagram illustration of a method for providing a document function check in accordance with an example embodiment of the disclosure.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

In the following description, numerous details are set forth to provide an understanding of the present disclosure. However, it will be understood by those of ordinary skill in the art that the present disclosure may be practiced without these details and that numerous variations or modifications from the described embodiments may be possible. The disclosure will now be described with reference to the figures, in which like reference numerals refer to like, but not necessarily the same or identical, elements throughout. For purposes of clarity in illustrating the characteristics of the present disclosure, proportional relationships of the elements have not necessarily been maintained in the figures.

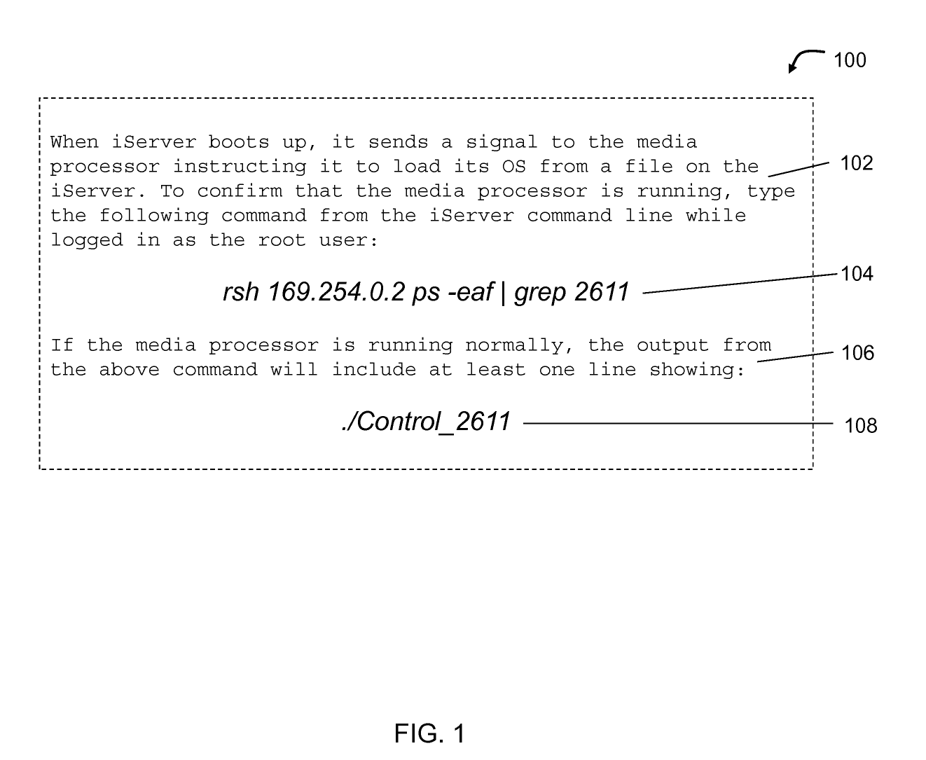

Referring now to the drawings in which like numerals represent like elements or steps throughout the several views, FIG. 1 schematically illustrates document excerpt 100 in accordance with an example embodiment of the disclosure. It will be appreciated that document excerpt 100 as shown here includes text, but may be any type of document, such as but not limited to a word processing file, spreadsheet, presentation, database record, programming object, text file, markdown file, or webpage.

In the beginning of some documents, a definition section is provided that defines terms and explains how certain document elements are used in a document. For example, the definition section may explain that safety warnings will appear throughout the document in a format with bold and italic text that is surrounded by a box. Additionally, the definition section may explain that document elements that are formatted with 10-point font in red represent a practice tip.

According to an aspect of the disclosure, text, tags, specific fonts, specific sizes, or other text formatting options may be used to indicate and designate document areas to be excluded from being spell checked. It will be appreciated that according to another aspect of the disclosure, it is possible to designate certain document sections with technical jargon to be excluded from being spell checked.

According to another aspect of the disclosure, designated document elements (such as a defined word) may be excluded from being spell checked throughout the document. According to another embodiment of the disclosure, the user may indicate that designated formatting/styles are to be excluded from document check functions. It will be appreciated that while documents are discussed, the disclosure applies to any type of program that does any type of document check function such as spell check.

Document excerpt 100 includes normal text element 102, designated text element 104, normal text element 106, and designated text element 108. For illustrative purposes, normal text elements 102 and 106 are depicted in Courier font while designated text elements 104 and 108 are shown depicted in italicized Arial font. As shown, the user has used formatting to indicate items 104 and 108 are to be designated text elements 104 and 108. As such, the document check function will identify designated text elements 104 and 108 based on the formatting and exclude them (104 and 108) from being spell checked. According to one aspect of the present disclosure, normal text elements 102 and 106 are included in document check operations while designated text elements 104 and 108 are excluded from document check operations.

Examples of document check operations include, but are not limited to spell checking and grammar checking. It will be appreciated that according to some embodiments, designated text elements may be excluded from some or all types of document check operations.

It will be appreciated, that the terms element and section may be used interchangeably herein. It will further be appreciated that the terms selected and designated may also be used interchangeably.

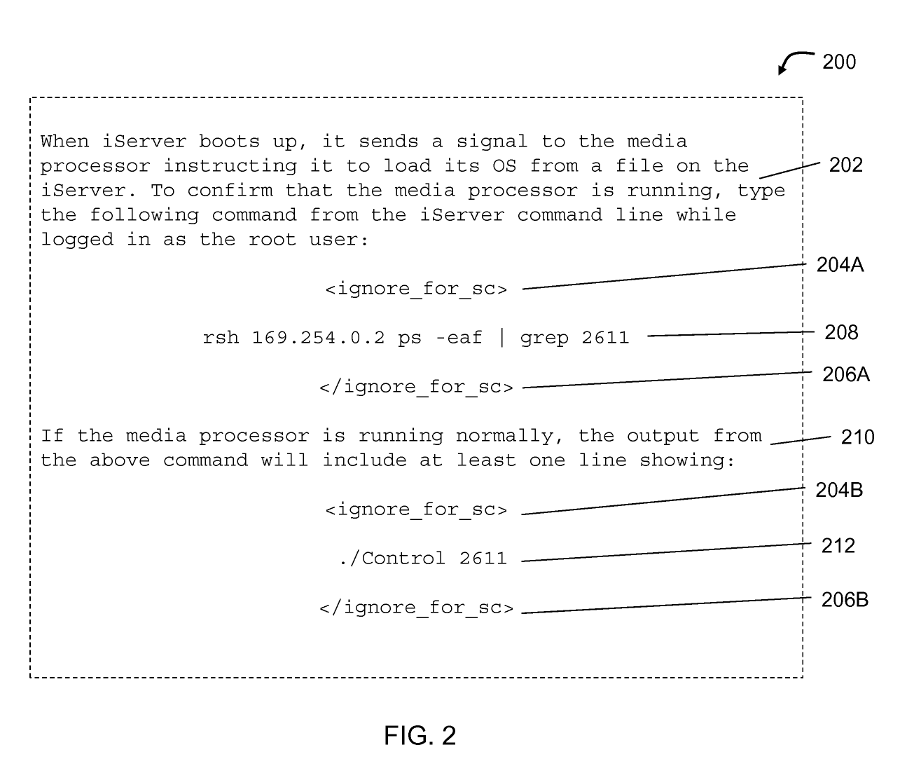

FIG. 2, schematically illustrates document excerpt 200 in accordance with an example embodiment of the disclosure. As shown document excerpt 200 is from a technical document. Document excerpt 200 includes normal text element 202, designated text element 208, normal text element 210, and designated text element 212.

Designated text elements 208 and 212 are enclosed by designators 204A, 206A and 204B, 206B, respectively. As shown in FIG. 2, designators 204A and 204B <ignore_for_sc> are shown as tags. More specifically, designators 204A and 204B are opening tags and act as first designators. Designators 206A and 206B </ignore_for_sc> are closing tags and act as second designators.

As shown, designator 206A is the corresponding or closing tag to designator 204A. According to one aspect of the disclosure, designated text elements 208 and 212 are differentiated from normal text elements 202 and 210 by their respective first (204A, 204B) and second (206A, 206B) designators.

Examples of first designator (204A, 204B) and second designator (206A, 206B) as shown in FIG. 2, are HTML tags, but it will be appreciated by one of ordinary skill in the art that any type of tag may be inserted to indicate that a particular section or element is not to be included in the spell check. According to another aspect of the disclosure, a user may right-click on elements or sections of text in the document and exclude them from the spell check by applying a tag. Examples of tags include markdown language, XML, html, and the like.

As described with respect to FIG. 1, according to an example embodiment of the disclosure, normal text elements 202 and 210 are included in document check operations while designated text elements 208 and 212 are excluded from document check operations.

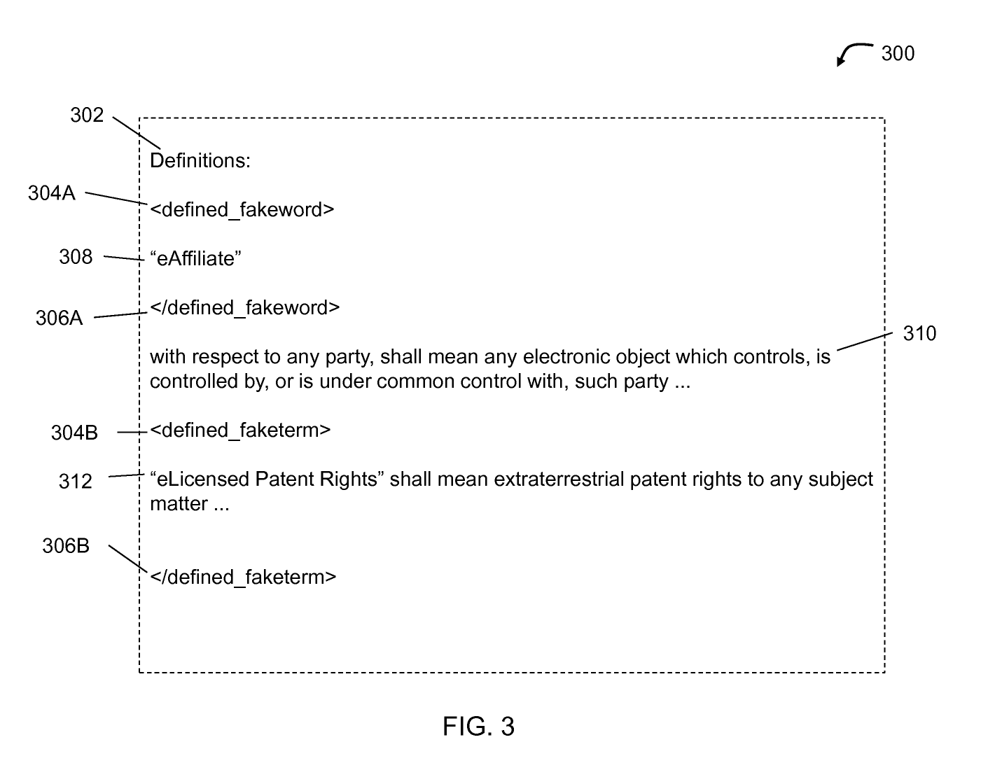

FIG. 3 schematically illustrates document excerpt 300 in accordance with an example embodiment of the disclosure. As shown document excerpt 300 is from a technical legal document. Document excerpt 300 includes normal text element 302, designated text element 308, normal text element 310, and designated text section 312.

Designated text element 308 and designated text section 312 are enclosed by designators 304A, 306A and 304B, 306B, respectively. As shown in FIG. 3, designator 304A <defined_fakeword> is shown as an opening tag and acts as a first designator. Designator 306A </defined_fakeword> is the corresponding closing tag for designator 304A.

Designator 304B <defined_faketerm> is another example of an opening tag/first designator. Designator 306B </defined_faketerm> is the corresponding closing tag for designator 304B. According to an example embodiment of the disclosure, designated text elements 308 and designated text section 312 are differentiated from normal text elements 302 and 310 by the respective first (304A, 304B) and second (306A, 306B) designators.

According to an aspect of the present disclosure and as described with respect to FIGS. 1 and 2, normal text elements 302, 310, and 314 are included in document check operations while designated text element 308 and designated text section 312 are excluded from document check operations.

Exemplary document excerpts 100, 200, and 300 shown in and described with respect to FIGS. 1-3 are provided by way of example only. Numerous other operating environments, system architectures, and device configurations are possible. Other system embodiments can include fewer or greater numbers of components and may incorporate some or all of the functionality described with respect to the system components shown in FIGS. 1-3. Accordingly, example embodiments of the disclosure should not be construed as being limited to any particular operating environment, system architecture, or device configuration.

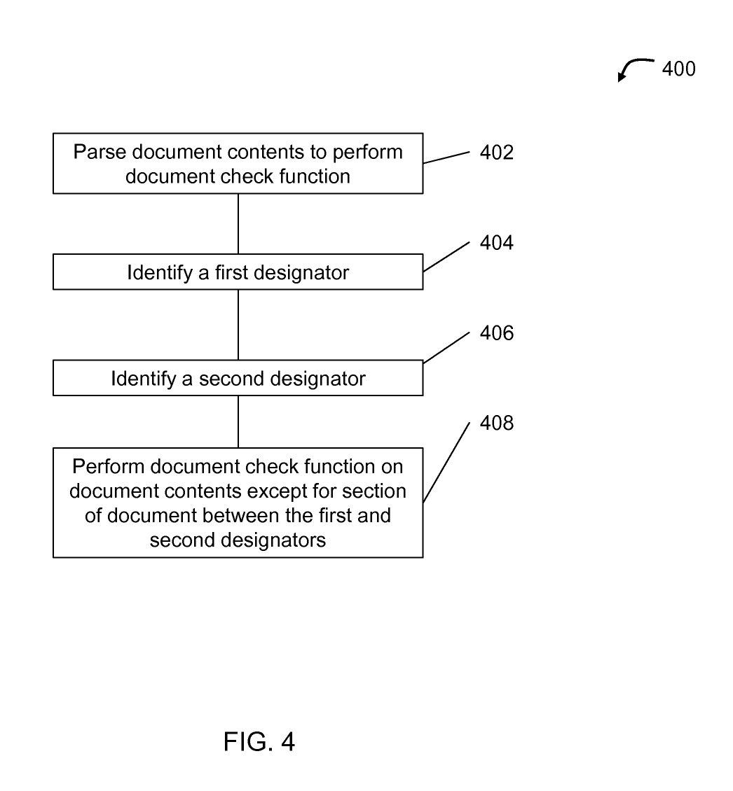

FIG. 4 is a block diagram illustration of instructions 400 for providing a document function check in accordance with an example embodiment of the disclosure. In block 402, the system parses the document contents to perform a document check function. As previously mentioned, example document check functions include but are not limited to spell check and grammar check. In block 404, the system operates to identify a first designator. As discussed with respect to FIGS. 1-3, first designators may include the beginning of special formatting applied to one or more areas (104, 108) and or include one or more tags such as 204A, 204B, 304A, and 304B. In block 406, the system operates to identify a second designator. As discussed with respect FIGS. 1-3, second designators may include the end of special formatting applied to one or more areas (104, 108) and or include one or more tags such as 206A, 206B, 306A, and 306B. In block 408, the system operates to perform the document check function on document contents except for the section of document between the first and second designators.

The flow chart of FIG. 4 shows the architecture, functionality, and operation of a possible implementation of providing an enhanced document check function. In this regard, each block represents a module, segment, or excerpt of code, which comprises one or more executable instructions for implementing the specified logical function(s). It should also be noted that in some alternative implementations, the functions noted in the blocks may occur out of the order noted in FIG. 4. For example, two blocks shown in succession in FIG. 4 may in fact be executed substantially concurrently or the blocks may sometimes be executed in the reverse order, depending upon the functionality involved. Any process descriptions or blocks in flow charts should be understood as representing modules, segments, or excerpts of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

As used herein, the term “computer-readable medium” may describe any form of memory or a propagated signal transmission medium. Propagated signals representing data and computer program instructions may be transferred between network devices and systems. Embodiments of computer-readable media include, but are not limited to, electronic, flash, optical, magnetic, or other storage or transmission device capable of providing a processor with computer-readable instructions. Also, various other forms of computer-readable media may transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Although the present disclosure has been described in detail, it should be understood that various changes, substitutions and alterations can be made thereto without departing from the spirit and scope of the disclosure as defined by the appended claims.

Therefore, at least the following is claimed:

1. A system for performing a document check function on a document, comprising:
a processor comprising a computer-readable medium with a set of instructions operable to:
parse a document;
identify a designated document section by locating a first designator within the document where the first designator indicates the beginning of a portion of the document to be bypassed by the document check function and locating a second designator within the document where the second designator indicates the end of the portion of the document to be bypassed by the document check function; and
perform the document check function on the document except for the designated document section.

2. The system of claim 1 where the first and second designators are selected from a group comprising a font, font size, font color, font case, font style, and tags.

3. The system of claim 1, further comprising instructions to:
identify an additional designated document section by locating a third designator within the document where the third designator indicates the beginning of a portion of the document to be bypassed by the document check function and locating a fourth designator within the document where the fourth designator indicates the end of the portion of the document to be bypassed by the document check function; and
perform the document check function on the document except for the additional designated document section.

4. The system of claim 1, where the designated document section is determined by a user.

5. The system of claim 1, wherein the document check function is a spell check function.

6. The system of claim 1, wherein the document check function is a grammar check function.

7. A system for performing a document check function on a document, comprising:
a processor comprising a computer-readable medium with a set of instructions operable to:
identify one or more excluded document sections in the document; and
perform the document check function on the document except for the one or more excluded document sections.

8. The system of claim 7, where the one or more excluded document sections are defined by a first designator and a second designator where the first and second designators indicate the beginning and end, respectively, of the one or more excluded document sections to be bypassed by the document check function.

9. The system of claim 8 where the first and second designators are selected from a group comprising a font, font size, font color, font case, font style, and tags.

10. The system of claim 7, wherein the document check function is a spell check function.

11. The system of claim 7, wherein the document check function is a grammar check function.

12. The system of claim 7, where the one or more excluded document sections are determined by a user.

13. A system for performing a document check function, comprising:
a processor comprising a computer-readable medium with a set of instructions operable to:
identify one or more excluded document sections by locating an open designator within the document where the open designator indicates the beginning of a portion of the document to be bypassed by the document check function and locating a close designator within the document where the close designator corresponds to the open designator and indicates the end of the portion of the document to be bypassed by the document check function; and
perform the document check function on the document except for the one or more excluded document sections.

14. The system of claim 13 where the open and close designators are selected from a group comprising a font, font size, font color, font case, font style, and tags.

15. The system of claim 13, wherein the document check function is a spell check function.

16. The system of claim 13, wherein the document check function is a grammar check function.

17. The system of claim 13, where the one or more excluded document sections are determined by a user.

18. The system of claim 13 wherein the open and close designators are markup tags.
